(19) United States
(12) Patent Application Publication
(10) Pub. No.: US 2003/0123887 A1
(43) Pub. Date: Jul. 3, 2003

(54) Adertising from the customer replaceable unit memory of a copier or printer cartridge

(75) Inventors: Edward P. Imes, Ontario, NY (US); James G. Stenzel, Rochester, NY (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/035,278

(22) Filed: Jan. 3, 2002

(51) Int. Cl. G03G 15/00

(52) U.S. Cl. 399/24

(57) ABSTRACT

The customer replacement unit memory of a replaceable cartridge for a copier or printer is pre-programmed to print advertising or promotion material.

### BACKGROUND OF THE INVENTION

The present invention relates to the customer replaceable unit memory (“CRUM”) of a cartridge for copiers or printers and, more particularly, to the printing of advertising or promotion material pre-programmed into the customer replaceable unit memory (“CRUM”) of a cartridge for copiers or printers.

In a typical electrophotographic printing process, a photoconductive member is charged to a substantially uniform potential so as to sensitize the surface thereof. The charged portion of the photoconductive member is exposed to a light image of an original document being reproduced. Typically, an original document to be reproduced is placed in registration, either manually or by means of an automatic document handler, on a platen for such exposure.

Exposure of the charged photoconductive member selectively dissipates the charges thereon in the irradiated areas. This dissipation records an electrostatic latent image on the photoconductive member corresponding to the informational areas contained within the original document. After the electrostatic latent image is recorded on the photoconductive member, the latent image is developed by bringing a developer material into contact therewith. Generally, the developer material comprises toner particles adhering triboelectrically to carrier granules.

The toner image formed by such development on the photoconductive member is subsequently transferred onto a copy sheet. The toner particles image on the sheet is then heated and permanently fused so as to form a “hardcopy” of the original image.

In printing and copying machines such as those described above, a CRU is a customer replaceable unit which can be replaced by a customer at the end of life or at the premature failure of one or more of the electrophotographic printing components. The CRU concept integrates various subsystems whose useful lives are predetermined to be generally the same length.

It is well known to provide a number of the elements and components, of an electrophotographic reproduction machine, in the form of a customer replaceable unit (CRU). Typically such units are each formed as a cartridge that can be inserted or removed from the machine frame by a customer or user. Reproduction machines such as copiers and printers ordinarily include consumable materials such as toner, volume limiting components such as a waste toner container, and life cycle limiting components such as a photoreceptor and a cleaning device. Because these elements of the copying machine or printer must be replaced frequently, they are more likely to be incorporated into a replaceable cartridge.

There are therefore various types and sizes of cartridges, varying from single machine element cartridges such as a toner cartridge, to all-in-one electrophotographic toner image forming and transfer process cartridges. One typical cartridge comprises a toner supply and the necessary supporting hardware therefor assembled in a single unit designed for insertion and removal into and out of the machine.

Customer replaceable units (CRUs) which may also be known as cartridges, i.e., process cartridges, are intended to be removed and replaced by a fairly untrained operator of the copy or printing machine. Typically, the CRU is replaced by first opening a cover or door and then sliding the CRU out of a cradle or location where the CRU fits within the machine. These CRUs are used to interact with the xerographic process and with the paper within the machine. Therefore, CRUs frequently need to be engaged into an operating position within the machine during the installation of the CRU. The CRU thus typically is slid or placed into the opening where it fits and then positioned into an operating arrangement within the printing machine. Typically, the used CRU must first be separated from the components with which it engages and then withdrawn from the printing machine. Similarly, a new replacement CRU must first be inserted into the machine and then interconnected with the operating portions of the printing machine.

In recent years, the replaceable print cartridge trend in small office/home office/desktop printers and copiers has been all-in-one single component development cartridges. One reason for this trend could be ease of customer use. A customer has only to replace one cartridge to replace the entire xerographic engine of their printer/copier. No separate dry ink, charging system cartridges, waste toner tanks, etc. need to be dealt with.

These toner or all-in-one cartridges typically have lives of 2000 to upwards of 25,000 prints. Cartridge life is usually terminated by an electronic customer replaceable unit memory (CRUM), a low toner sensor, or when the cartridge simply runs out of toner (giving light prints or deletions).

The CRUM of a cartridge typically serves as the vehicle for billing the customer for the number of prints or copies made and to warrantee the cartridge components for a specified number of prints. Once all of the prints have been made and the cartridge is exhausted, the cartridge is disabled and no further prints can be made by the cartridge. The cartridge will also give the customer a warning when the cartridge is close to the end of its life so that there is time for the customer to obtain a fresh cartridge before the old cartridge is used up.

It is an object of this invention to provide a customer replaceable unit memory (CRUM) for a cartridge for copiers or printers pre-programmed to print advertising or promotion material.

### SUMMARY OF THE INVENTION

According to the present invention, the customer replacement unit memory of a replaceable cartridge for a copier or printer is pre-programmed to print advertising or promotion material. The cartridge can be the toner cartridge, the photoreceptor cartridge or the developer cartridge for an electrophotographic printer.

The customer replacement unit memory is pre-programmed with a maximum count reflecting the maximum number of images that can be produced with the cartridge. The customer replacement unit memory maintains a count of images produced with the cartridge. The customer replacement unit memory can print the advertising or promotion material upon initial installation and activation of the cartridge in the copier or printer, upon printing a specified number of images equal to the warning count, upon printing a specified number of images equal to the termination count, upon printing a specified number of images, or upon a series of specified image counts.

Other objects and attainments together with a fuller understanding of the invention will become apparent and appreciated by referring to the following description and claims taken in conjunction with the accompanying drawings.

### BRIEF DESCRIPTION OF THE DRAWINGS

A more complete appreciation of the invention and many of the attendant advantages thereof will be readily obtained and understood by referring to the following detailed description and the accompanying drawings in which like reference numerals denote like elements as between the various drawings. The drawings, briefly described below, are not to scale.

FIG. 1 is a schematic elevational view of an electrophotographic reproducing machine having replaceable photoreceptor, developer, and toner cartridges, each cartridge having a customer replaceable unit memory (CRUM) to provide advertising in accordance with the teachings of the present invention.

FIG. 2 is a perspective view showing details of the replaceable photoreceptor cartridge for the electrophotographic reproducing machine shown in FIG. 1 together with the mechanism for establishing electrical contact between the photoreceptor cartridge CRUM and the machine control unit on insertion of the cartridge into place.

FIG. 3 is a perspective view showing details of the replaceable developer cartridge and toner cartridge for the electrophotographic reproducing machine, each cartridge having a customer replaceable unit memory (CRUM) to provide printing of advertising or promotion material at a specified point in the printing, shown in FIG. 1.

FIG. 4 is a control schematic showing details of the machine control unit and the coupling therewith the CRUMs of the xerographic cartridge, the developer cartridge and the toner cartridge.

### DESCRIPTION OF THE INVENTION

In the following detailed description, numeric ranges are provided for various aspects of the embodiments described. These recited ranges are to be treated as examples only, and are not intended to limit the scope of the claims hereof. In addition, a number of materials are identified as suitable for various facets of the embodiments. These recited materials are to be treated as exemplary, and are not intended to limit the scope of the claims hereof.

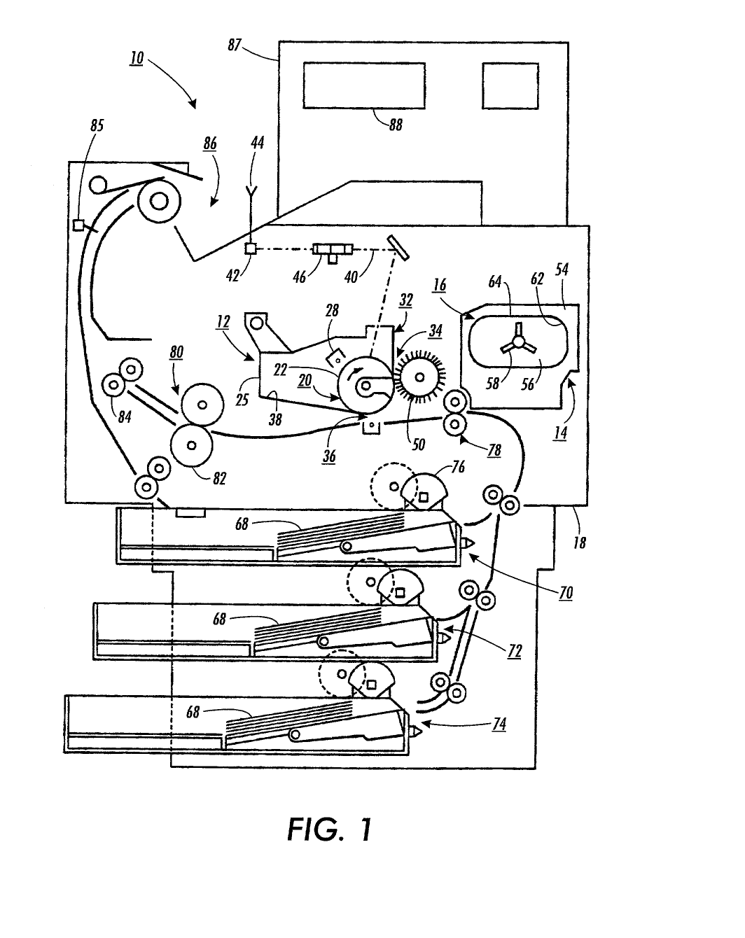

Referring to FIGS. 1 to 3, there is shown by way of example an automatic electrophotographic reproducing machine 10 of the type adapted to implement the system of the present invention shown. The reproducing machine 10 comprises a laser printer employing a replaceable photoreceptor cartridge 12, a replaceable developer cartridge 14, and a replaceable toner cartridge 16 respectively, each of which is designed to provide a preset number of images in the form of prints or copies. And, while the machine 10 is exemplified in the ensuing description and drawings as a printer, other types of reproducing machines such as copiers, ink jet printers, etc. may be envisioned.

Cartridges 12, 14, 16 are each warranted to produce a preset number of images (Y). When the number of remaining images reaches a predetermined level (X), a warning is given. This warning is to allow the customer time to order a new cartridge. After the warning has been given, the machine will continue to make the last remaining images (X). At this point, the total images (Y) have been made, the cartridge is disabled, and further operation of machine 10 is prevented. At that point, the “dead” cartridge 12, 14, or 16 must be removed and replaced by a new “live” cartridge for further operation of the machine 10.

The photoreceptor cartridge 12 includes a photoreceptor drum 20, the outer surface 22 of which is coated with a suitable photoconductive material, and a charge corotron 28 for charging the drum photoconductive surface 22 in preparation for imaging. The drum 20 is suitably journaled for rotation within the cartridge body 25, the drum 20 rotating in the direction indicated by the arrows to bring the photoconductive surface thereof past exposure, developer, and transfer stations 32, 34, 36 of the machine 10 on installation of the cartridge 12 in the machine. To receive the photoreceptor cartridge 12, a suitable cavity 38 is provided in the machine frame 18, the cartridge body 25 and the cavity 38 having complementary shapes and dimensions such that on insertion of the cartridge 12 into the cavity 38, the drum 20 is in a predetermined operating relation with exposure, developer, and transfer stations 32, 34, 36 respectively. With insertion of the cartridge 12, the drum 20 is drivingly coupled to the drum driving means (not shown) and the electrical connections to the cartridge 12 made.

In the photoreceptor process practiced, the photoconductive surface 22 of the drum 20 is initially uniformly charged by the charge corotron 28, following which the charged photoconductive surface 22 is exposed by the imaging beam 40 at the exposure station 32 to create an electrostatic latent image on the photoconductive surface 22 of the drum 20.

The imaging beam 40 is derived from a laser diode 42 modulated in accordance with image signals from a suitable source 44. The image signal source 44 may comprise any suitable source of image signals such as memory, document scanner, internet or communication link, etc. The modulated imaging beam 40 output by the laser diode 42 is impinged on the facets of a rotating multi-faceted polygon 46 which sweeps the beam across the photoconductive surface 22 of the drum 20 at the exposure station 32.

Following exposure, the electrostatic latent image on the photoconductive surface 22 of the drum 20 is developed by a magnetic brush development system contained in the developer cartridge 14. The magnetic brush development system includes a suitable magnetic brush roll 50 rotatably journaled in the body 52 of the cartridge 14, the developer being supplied to the magnetic brush roll 50 by the toner cartridge 16. To receive the developer cartridge 14, a suitable cavity 54 is provided in the machine frame 18, the cartridge body 52 and the cavity 54 having complementary shapes and dimensions such that on insertion of the cartridge 14 into the cavity 54, the magnetic brush roll 50 is in predetermined developing relation with the photoconductive surface 22 of the drum 20. With insertion of the cartridge 14, the magnetic brush roll 50 is drivingly coupled to the developer driving means (not shown) in the machine 10 and the electrical connections to the cartridge 14 made.

The toner cartridge 16 provides a sump 56 within which toner for the magnetic brush development system in the developer cartridge 14 is provided. A rotatable auger 58 mixes the toner is sump 56 and provides toner to the magnetic brush roll 50. The magnetic brush roll 50 is suitably journaled for rotation in the body 52 of the cartridge 16.

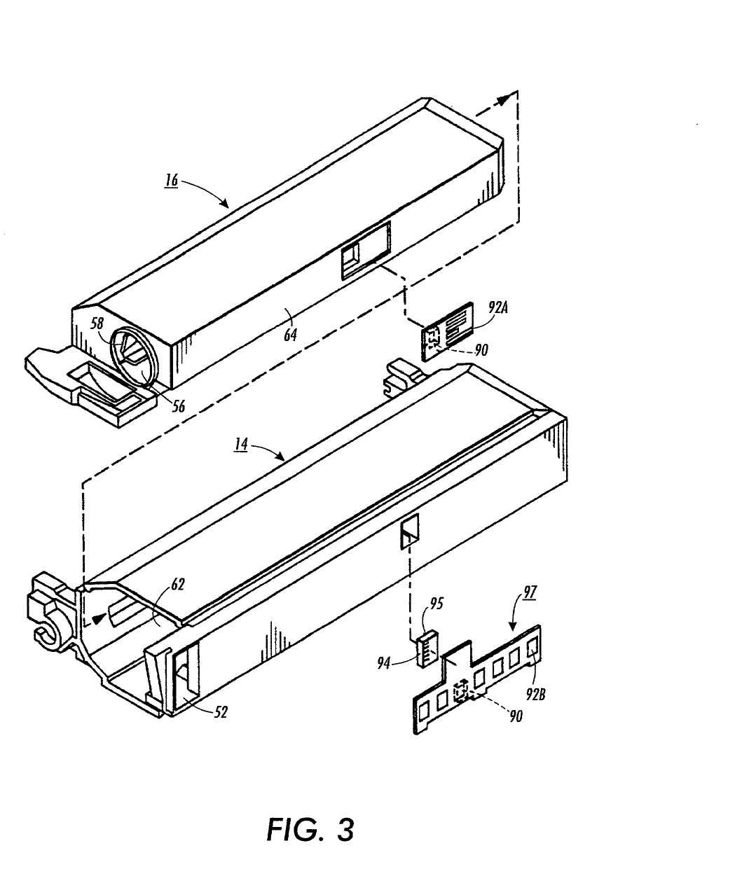

As seen best in FIG. 3, the body 52 of the developer cartridge 14 forms a cavity 62 for receipt of the toner cartridge 16, the cavity 62 of the cartridge 14 and the body 64 of the cartridge 16 having complementary shapes and dimensions such that on insertion of the cartridge 16 into the cavity 62, the cartridge 16 is in predetermined operating relation with the magnetic brush roll 50 in the developer cartridge 14. With insertion of the toner cartridge 16, the auger 58 is drivingly coupled to the developer driving means (not shown) and the electrical connections to the cartridge 16 made.

Prints of the images formed on the photoconductive surface of the drum 20 are produced by the machine 10 on a suitable support material, such as a copy sheet 68 or the like. A supply of copy sheets 68 is provided in the plural paper trays 70, 72, 74. Each tray 70, 72, 74 has a feed roll 76 for feeding individual sheets from the stack of sheets in the tray 70, 72, 74 to a registration pinch roll pair 78. Following registration, the sheet is forwarded to the transfer station 36 in proper timed relation with the developed image on the drum 20. There, the developed image is transferred to the copy sheet 68. Following transfer, the copy sheet bearing the toner image is separated from the photoconductive surface 22 of the drum 20 and advanced to the fixing station 80 wherein the roll fuser 82 fixes the transferred powder image thereto the copy sheet 68. A suitable sheet sensor 85 senses each finished print as the print passes from the fixing station 80 to the output tray 86. After fusing the toner image to the copy sheet, the sheet 68 is advanced by the print discharge rolls 84 to the print output tray 86.

Any residual toner particles remaining on the photoconductive surface 22 of the drum 20 after transfer are removed by a cleaning mechanism (not shown) in the photoreceptor cartridge 12.

To control operation of the machine 10, a suitable control panel 87 with various control and print job programming elements is provided. The panel 87 additionally includes a suitable message display window 88 for displaying various operating information to the machine operator.

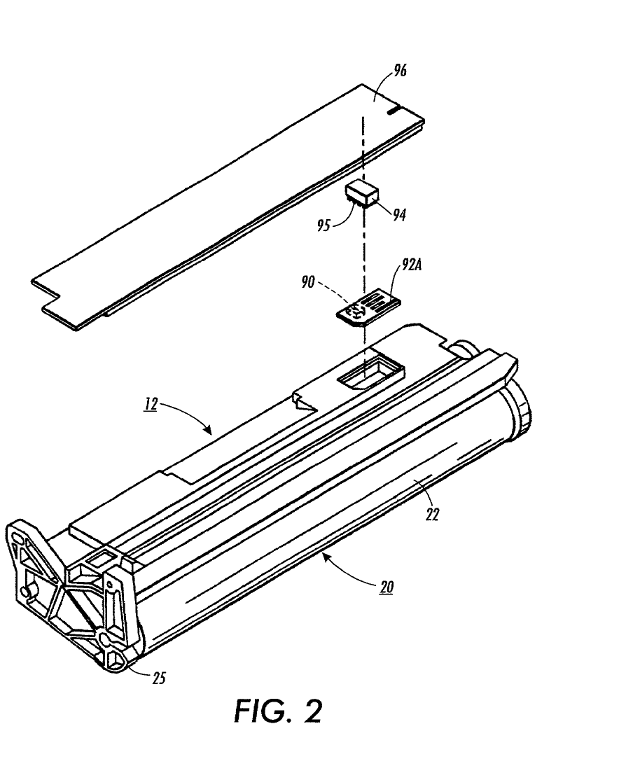

Referring particularly to FIGS. 2 and 3, in order to assure that only authorized and unexpired xerographic, developer, and toner cartridges are used as well as to maintain running count of the number of images made with each cartridge and prevent further use when the cartridge is used up, each cartridge 12, 14, 16 has an identification/memory chip in the form of a customer replaceable unit memory (CRUM) 90 integral therewith.

The CRUM 90 allows the machine 10 to send a reorder message, either through the user interface or automatically, for the cartridge; monitors the number of copies printed by the machine 10; provides a handshake feature with the machine to ensure the correct cartridge is installed in the machine 10; shuts down the machine 10 at the appropriate cartridge termination point; enables cartridge life cycle planning for remanufacture; enables remote diagnostics; and provides a safety interlock for the machine 10.

The CRUM 90 can be, in this illustrative example, an Electrically Erasable Programmable Read Only Memory (EEPROM). Alternately, the CRUM can be any type of electronic memory such as ROM, RAM, magnetic stripe, barcode or an optical memory system. Further it is possible that the CRUM may include multiple memory means of different types.

To enable CRUMs 90 to be electrically connected and disconnected with the machine on installation or removal of the cartridges, contact pads 92A or 92B are provided. Terminal blocks 94 and a terminal board 97 are employed to complete the electrical connection between the CRUMs 90 and the machine control unit.

As seen in FIG. 2, the terminal block 94 for the xerographic cartridge 12 is mounted on a part 96 of the cavity 38 within which the xerographic cartridge 12 fits. On installation of the xerographic cartridge 12, the contact pads 92A of the xerographic cartridge CRUM 90 engage the contacts 95 of the terminal block 94 to complete the electrical connection to the CRUM. As seen in FIG. 3, the terminal block 94 for the toner cartridge 16 is mounted on the terminal board 97. The CRUM 90 for the developer cartridge 14 is also mounted on the board 97. The contact pads 92B on the board 97 serve to electrically couple the CRUM 90 of the developer cartridge and, through the intermediary of the terminal block 94, the CRUM 90 of the toner cartridge 16 to the machine control unit. On installation of the toner cartridge 16 into the cavity 62 formed by the developer cartridge 14, the contact pads 92A of the toner cartridge CRUM 90 engage the contacts 95 of the terminal block 94 for the toner cartridge 14 on the board 97. On installation of the developer cartridge 14 into the machine 10, the contacts 92B for both the CRUM 90 of the toner cartridge 16 and the CRUM 90 of the developer cartridge 14 mate to a second set of contacts mounted on the machine frame 18 (not shown) to complete the electrical connection.

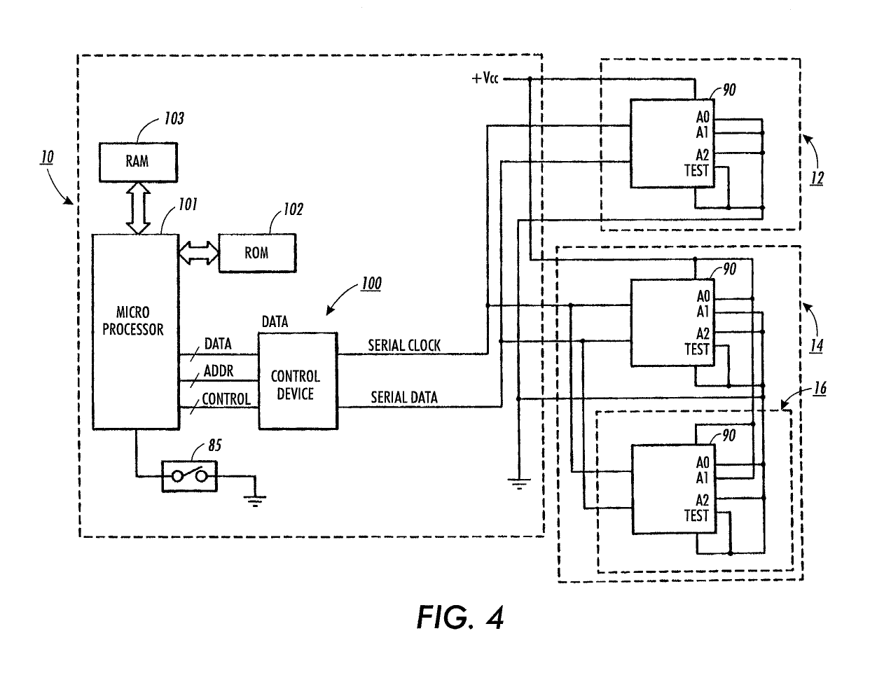

Referring now to FIG. 4, a suitable machine control unit (MCU) 100 which includes one or more microprocessors 101 and suitable memory, such as ROM and RAM memories 102, 103 respectively for holding the machine operating system software, programming data, etc., is provided for operating the various component parts of the machine 10 in an integrated fashion to produce prints.

The CRUMs 90 for each cartridge 12, 14, 16 provide addressable memory for storing or logging a count of the number of images remaining on each cartridge, the count being stored on the various CRUMs 90 by the control unit 100 at the end of each run. Each CRUM is pre-programmed with a maximum count Y reflecting the maximum number of images that can be made by the cartridge. The counting system is a decrementing type system with the count Y in CRUMs 90 being decremented as images are made to provide a current image count. When the current image count Y reaches a termination count which in the example described is zero, the cartridge is rendered unusable. To alert or warn the customer when the cartridge is nearing the end of life, a warning count X reflecting the predetermined number of remaining images left on the cartridge is also provided in CRUMs 90. When the warning image count X is reached, a message is displayed in message display window 88 of control panel 87 to warn the operator that the cartridge currently in use is nearing end of life and should be replaced. Typically the warning count X provides a few hundred to a few thousand images within which the operator must obtain a replacement cartridge if continued operation of the machine is to be assured.

The maximum image count Y and the warning image count X are typically pre-programmed into the CRUMs 90 at the factory. Additionally, in order to assure that only authorized CRUMs are used, an identification number is pre-programmed and stored in the CRUM for each cartridge 12, 14, 16.

Whenever machine 10 is powered up, an initialization routine is entered in which the identification numbers of cartridges 12, 14, 16 are read and compared with the corresponding recognition numbers stored in ROM 102. Where the identification number of any cartridge does not match the recognition number for that cartridge, operation of machine 10 is prevented and the message (WRONG TYPE CARTRIDGE) is displayed in the display window 88.

Presuming that the correct cartridges are installed, a check is made to see if the cartridges have reached the end of the cartridge life. For this, the current image count logged in each CRUM 90 is obtained and compared with the termination count, here zero. Where the current image count on the CRUM is equal to or less than zero, the cartridge is exhausted and the message (END OF LIFE) is displayed for the exhausted cartridge in the display window 88. Operation of machine 10 is inhibited until the exhausted cartridge is replaced. Presuming that the cartridges 12, 14, 16 have not reached the end of life (and that no other faults are found), the machine enters the standby state ready to make prints.

On a print request, the machine 10 cycles up and commences to make prints. The control unit 100 counts each time a finished print is detected by the print sensor 85 as the finished print passes from the fixing station 80 into the output tray 86. When the print run is completed and the machine cycles down, the total number of images made during the run, i.e., the image run count, is temporarily stored in the RAM 103. The control unit 100 fetches the current image count from the CRUM 90 of each cartridge 12, 14, 16 and, using the image run count from RAM 103, calculates a new current image count for each CRUM 90 reflecting the number of images remaining on the cartridge. The control unit 100 then writes the new current image count back into the individual CRUMs 90 of each cartridge 12, 14, 16.

Prior to returning the new current image counts to CRUMs 90, the control unit 100 compares each new current image count against the warning count X stored in CRUMs 90 of each cartridge 12, 14, 16. Where the new current image count is equal to or less than the warning count X, a message (ORDER REPLACEMENT CARTRIDGE) is displayed for the particular cartridge in the control panel message display window 88. This alerts the operator to the fact that the identified cartridge is about to expire and that a new replacement cartridge should be available.

The new current image count for each cartridge is also compared with the termination count, exemplified here by zero. Where the current image count is equal to or less than zero for a cartridge, the cartridge is disabled and the message (ENID OF LIFE) for the cartridge is displayed in the message display window 88. The control unit 100 prevents further operation of the machine 10 until the expired cartridge is replaced by a fresh cartridge.

In accordance with the present invention, on installation of the new toner cartridge 16, after the identification number of the toner cartridge 16 has matched the recognition number for the toner cartridge in the control unit 100, the CRUM 90 of the new toner cartridge 16 is pre-programmed to cause the machine 10 to print advertising or promotion material on the initial copy sheet or sheets 68. The advertising or promotion material may be specific to the toner cartridge 16, the machine 10, the manufacturer of the toner cartridge or the machine, or be general in nature. The printing of the advertising or promotion material in this embodiment is intended to be one time only and only upon the initial installation and activation of the toner cartridge. The printing of the advertising or promotion material can be part of the sample sheets 68 made to demonstrate copier or printer quality.

Alternately and in accordance with the present invention, when the current image count Y in the CRUM 90 of the toner cartridge 16 reaches the warning count X, the CRUM 90 of the toner cartridge 16 is pre-programmed to cause the machine 10 to print advertising or promotion material on the copy sheet or sheets 68. The advertising or promotion material may be specific to the toner cartridge 16, the machine 10, the manufacturer of the toner cartridge or the machine, or be general in nature. The printing of the advertising or promotion material in this embodiment is intended to be one time only.

Also alternately and in accordance with the present invention, when the current image count Y in the CRUM 90 of the toner cartridge 16 reaches the termination count 0, prior to disabling the toner cartridge 16, the CRUM 90 of the toner cartridge 16 is pre-programmed to cause the machine 10 to print advertising or promotion material on the copy sheet or sheets 68. The advertising or promotion material may be specific to the toner cartridge 16, the machine 10, the manufacturer of the toner cartridge or the machine, or be general in nature. The printing of the advertising or promotion material in this embodiment is intended to be one time only.

However, the printing of the advertising or promotion material need not be one time only. The printing of the advertising or promotion material on the copy sheet 68 can occur on both initial activation and at the warning count of the toner cartridge 16; at both the warning count and the termination count of the toner cartridge 16; at both the initial activation and the termination count of the toner cartridge 16; or at all three of the initial activation, the warning count and the termination count of the toner cartridge 16. The advertising and promotion material need not be the same at any of the specific points of printing. The advertising and the point of printing are pre-programmed into the CRUM 90 of the toner cartridge 16.

Similarly, the CRUM 90 of the toner cartridge 16 can be pre-programmed to print the advertising or promotion material on the copy sheet 68 at specified image counts or events between the maximum image count and the termination count of zero. And again, the advertising and promotion material need not be the same at any of the specific points of printing. The advertising and the point of printing are pre-programmed into the CRUM 90 of the toner cartridge 16.

Alternately and in accordance with the present invention, on installation of the new photoreceptor cartridge 12, after the identification number of the photoreceptor cartridge 12 has matched the recognition number for the photoreceptor cartridge in the control unit 100, the CRUM 90 of the new photoreceptor cartridge 12 is pre-programmed to cause the machine 10 to print advertising or promotion material on the initial copy sheet or sheets 68. The advertising or promotion material may be specific to the photoreceptor cartridge 12, the machine 10, the manufacturer of the photoreceptor cartridge or the machine, or be general in nature. The printing of the advertising or promotion material in this embodiment is intended to be one time only and only upon the initial installation and activation of the photoreceptor cartridge. The printing of the advertising or promotion material can be part of the sample sheets 68 made to demonstrate copier or printer quality.

Also alternately, the CRUM 90 of the photoreceptor cartridge 12 can be pre-programmed to print advertising or promotion material on the copy sheet or sheets 68 when the current image count Y in the CRUM 90 of the photoreceptor cartridge 12 reaches the warning count X or the termination count 0.

Again alternatively, the CRUM 90 of the photoreceptor cartridge 12 can be pre-programmed to print advertising or promotion material on the copy sheet or sheets 68 at more than one specific point in the printing including the initial activation of the photoreceptor cartridge, the warning count X, the termination count 0 or at specified image counts.

Alternately and in accordance with the present invention, on installation of the new developer cartridge 14, after the identification number of the photoreceptor cartridge 12 has matched the recognition number for the developer cartridge in the control unit 100, the CRUM 90 of the new developer cartridge 14 is pre-programmed to cause the machine 10 to print advertising or promotion material on the initial copy sheet or sheets 68. The advertising or promotion material may be specific to the developer cartridge 14, the machine 10, the manufacturer of the developer cartridge or the machine, or be general in nature. The printing of the advertising or promotion material in this embodiment is intended to be one time only and only upon the initial installation and activation of the toner cartridge. The printing of the advertising or promotion material can be part of the sample sheets 68 made to demonstrate copier or printer quality.

Also alternately, the CRUM 90 of the developer cartridge 14 can be pre-programmed to print advertising or promotion material on the copy sheet or sheets 68 when the current image count Y in the CRUM 90 of the developer cartridge 14 reaches the warning count X or the termination count 0.

Again alternatively, the CRUM 90 of the developer cartridge 14 can be pre-programmed to print advertising or promotion material on the copy sheet or sheets 68 at more than one specific point in the printing including the initial activation of the developer cartridge, the warning count X, the termination count 0 or at specified image counts.

In accordance with the present invention, the CRUMs 90 of the photoreceptor cartridge 12, the developer cartridge 14 and the toner cartridge 16 can each be pre-programmed to print advertising or promotion material on the copy sheet or sheets 68.

The information on the CRUM might be encrypted such that only manufactured or re-manufactured cartridges from a specific manufacturer would have the ability to be read, thus preventing this capacity from being capitalized on by refillers.

While the invention has been described in conjunction with specific embodiments, it is evident to those skilled in the art that many alternatives, modifications and variations will be apparent in light of the foregoing description. Accordingly, the invention is intended to embrace all such alternatives, modifications and variations as fall within the spirit and scope of the appended claims.

What is claimed is:

1. A replaceable unit relating to an output of a predetermined number of prints in an electrophotographic printer, comprising:
a memory, permanently associated with the replaceable unit, adapted to retain counting data relating to a cumulative number of prints relating to the replaceable unit, said memory causing said electrophotographic printer to print advertising or promotion material upon a specified event.

2. The replaceable unit relating to an output of a predetermined number of prints in an electrophotographic printer of claim 1 wherein said specified event is the initial installation and activation of said replaceable unit in said electrophotographic printer.

3. The replaceable unit relating to an output of a predetermined number of prints in an electrophotographic printer of claim 1 wherein said specified event is the printing of a specified number of prints.

4. The replaceable unit relating to an output of a predetermined number of prints in an electrophotographic printer of claim 3 wherein said specified number of prints is the warning count, said warning count being a specified number of prints away from the end of life of said replaceable unit programmed into said memory.

5. The replaceable unit relating to an output of a predetermined number of prints in an electrophotographic printer of claim 3 wherein said specified number of prints is the termination count, said termination count being the end of life of said replaceable unit programmed into said memory.

6. The replaceable unit relating to an output of a predetermined number of prints in an electrophotographic printer of claim 1 further comprising a series of specified events in said memory causing said electrophotographic printer to print advertising or promotion material.

7. The replaceable unit relating to an output of a predetermined number of prints in an electrophotographic printer of claim 1 wherein the memory comprises an EEPROM.

8. The replaceable unit relating to an output of a predetermined number of prints in an electrophotographic printer of claim 1 further comprising a toner supply for said electrophotographic printer.

9. The replaceable unit relating to an output of a predetermined number of prints in an electrophotographic printer of claim 1 further comprising a photoreceptor for said electrophotographic printer.

10. The replaceable unit relating to an output of a predetermined number of prints in an electrophotographic printer of claim 1 further comprising a developer for said electrophotographic printer.
